(19) United States
(12) Patent Application Publication
(10) Pub. No.: US 2026/0282152 A1
(43) Pub. Date: Sep. 17, 2026

(54) MANAGING NETWORK-INITIATED SMALL DATA TRANSMISSION

(71) Applicant: GOOGLE LLC, Mountain View, CA (US)

(72) Inventor: Chih-Hsiang Wu, Taoyuan City (TW)

(21) Appl. No.: 19/471,341

(22) PCT Filed: Mar. 31, 2024
(86) PCT No.: PCT/US24/22433

§ 371 Date: Sep. 30, 2025

Related U.S. Application Data
(60) Provisional application No. 63/493,709, filed on Mar. 31, 2023.

(51) Int. Cl. H04W 76/20; H04W 28/02; H04W 88/08

(52) U.S. Cl. CPC H04W 76/20; H04W 28/0252; H04W 88/085

(57) ABSTRACT

A central unit (CU) of a distributed base station including the CU and a distributed unit (DU) receives (404), at a user plane (UP) entity of the CU (CU-UP) from a control plane (CP) entity of the CU (CU-CP), a request to modify a bearer context for a user equipment (UE), the request including information related to mobile-terminated small data transmission (MT-SDT); receives (410), at the CU-UP and in an inactive state of a radio connection between the UE and a radio access network (RAN), downlink (DL) data for the UE; and transmits (412), from the CU-UP to the CU-CP, an indication of the DL data, the indication including an MT-SDT indication, based on the information related to the MT-SDT received from the CU-CP.

### CROSS-REFERENCE TO RELATED APPLICATION

This application claims priority to and the benefit of the filing date of provisional U.S. Patent Application No. 63/493,709, entitled “Managing Network-Initiated Small Data Transmission,” filed on Mar. 31, 2023. The entire contents of the provisional application are hereby expressly incorporated herein by reference.

### FIELD OF THE DISCLOSURE

This disclosure relates generally to wireless communications and, more particularly, to communication of uplink and/or downlink data at a user equipment (UE) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. In some cases, the UE in the RRC_INACTIVE state has only one, relatively small packet to transmit. In these cases, the UE in the RRC_INACTIVE state can initiate a small data transmission (SDT) without transitioning to the RRC_CONNECTED state, e.g., by using techniques as specified in section 18.0.0 in 3GPP specification 38.300v 17.4.0.

A distributed base station may have a DL small data packet for the UE that operates in the RRC_INACTIVE state without an ongoing SDT session. It is not clear how the distributed base station including a central unit (CU) control plane (CP) function, a CU user plane (UP) function and a distributed unit (DU) should support mobile-terminated small data communication with a UE.

### SUMMARY

An example embodiment of the techniques of this disclosure is a method implemented in a central unit (CU) of a distributed base station including the CU and a distributed unit (DU). The method comprises receiving, at a user plane (UP) entity of the CU (CU-UP) from a control plane (CP) entity of the CU (CU-CP), a request to modify a bearer context for a user equipment (UE), the request including information related to mobile-terminated small data transmission (MT-SDT); receiving, at the CU-UP and in an inactive state of a radio connection between the UE and a radio access network (RAN), downlink (DL) data for the UE; and transmitting, from the CU-UP to the CU-CP, an indication of the DL data, the indication including an MT-SDT indication, based on the information related to the MT-SDT received from the CU-CP.

Another embodiment of these techniques is a base station comprising processing hardware and configured to implement the method above.

### BRIEF DESCRIPTION OF THE DRAWINGS

FIG. 1A is a block diagram of an example wireless communication system in which a user device and a base station of this disclosure can implement the techniques of this disclosure for managing downlink early data transmission (EDT);

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is an example message sequence in which a CU determines to initiate SDT and sends an SDT indication to a DU, which causes the DU to generate a paging message for a UE indicating that the UE is to initiate SDT;

FIG. 4A is an example message sequence similar to the message sequences of FIG. 3, but where a CU-UP, a user plane node of the CU, determines to initiate SDT and transmits an SDT indication to a CU-CP, a control plane node of the CU;

FIG. 4B is an example message sequence similar to the message sequences of FIG. 3, but where a CU-CP determines to initiate SDT to transmit small data received from a core network;

FIGS. 5A-5D are flow diagrams of example methods for transmitting an interface message to a DU that includes an SDT indication to cause the DU to transmit a paging message to the UE that includes an SDT indication, which can be implemented by a CU-CP;

FIGS. 6A-6D are flow diagrams of example methods for transmitting an interface message to a base station that includes an SDT indication to cause the base station to transmit a paging message to the UE that includes an SDT indication, which can be implemented by a CU-CP;

FIG. 7 is a flow diagram of an example method for performing a bearer context procedure to resume at least one UP bearer for a UE in response to receiving CP data for the UE, which can be implemented by a CU-CP;

FIG. 8 is a flow diagram of an example method for determining whether to include an SDT indication in a DU-to-CU message for a UE, which can be implemented by a DU;

FIG. 9 is a flow diagrams of an example method for performing a UE Context procedure (e.g., a UE Context Setup procedure or a UE Context Modification procedure) for mobile-terminated SDT (MT-SDT), which can be implemented by a CU;

FIG. 10 is a flow diagram of an example method for performing a UE Context procedure for random access SDT (RA-SDT), configured grant SDT (CG-SDT), MT-SDT or non-SDT, which can be implemented by a CU;

FIG. 11 is a flow diagrams of an example method for performing a UE Context procedure (e.g., a UE Context Setup procedure or a UE Context Modification procedure) for MT-SDT, which can be implemented by a DU;

FIG. 12 is a flow diagram of an example method for performing a UE Context procedure for SDT or non-SDT, which can be implemented by a DU;

FIG. 13 is a flow diagram of an example method for performing a UE Context procedure for SDT or non-SDT, which can be implemented by a CU;

FIG. 14 is a flow diagram of an example method for transmitting an interface message that includes an MT-SDT indication in some cases, which can be implemented by a CU-CP;

FIG. 15 is a flow diagram of an example method for transmitting an interface message indicating arrival of downlink data for UE, which includes an MT-SDT indication in some cases, which can be implemented by a CU-CP; and

FIGS. 16A-B are flow diagrams of example methods for transmitting an interface message indicating arrival of downlink data for UE, which includes an MT-SDT indication in some cases, which can be implemented by a CU-UP.

### DETAILED DESCRIPTION OF THE DRAWINGS

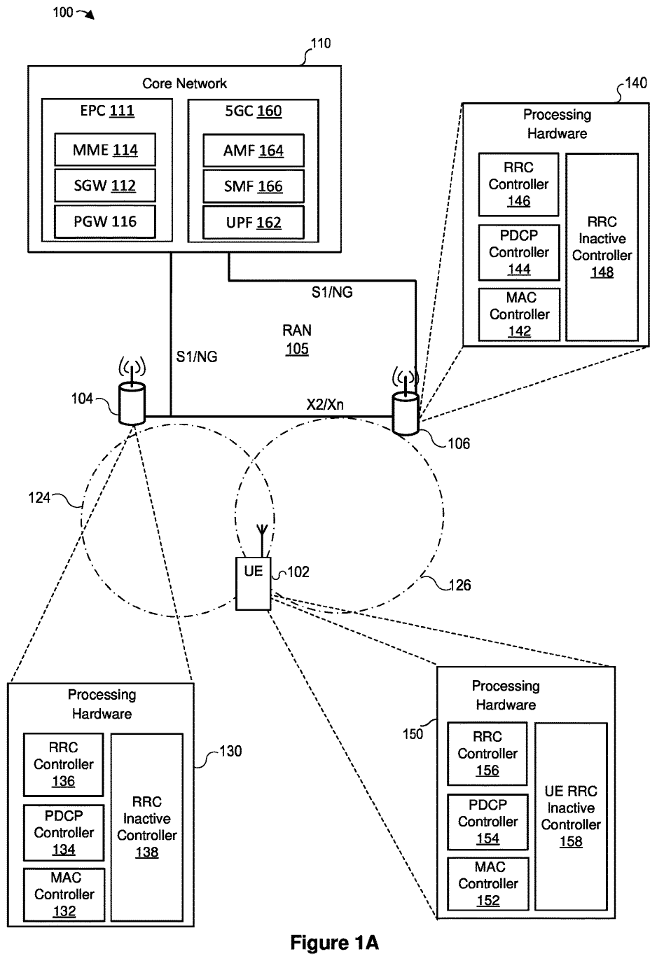

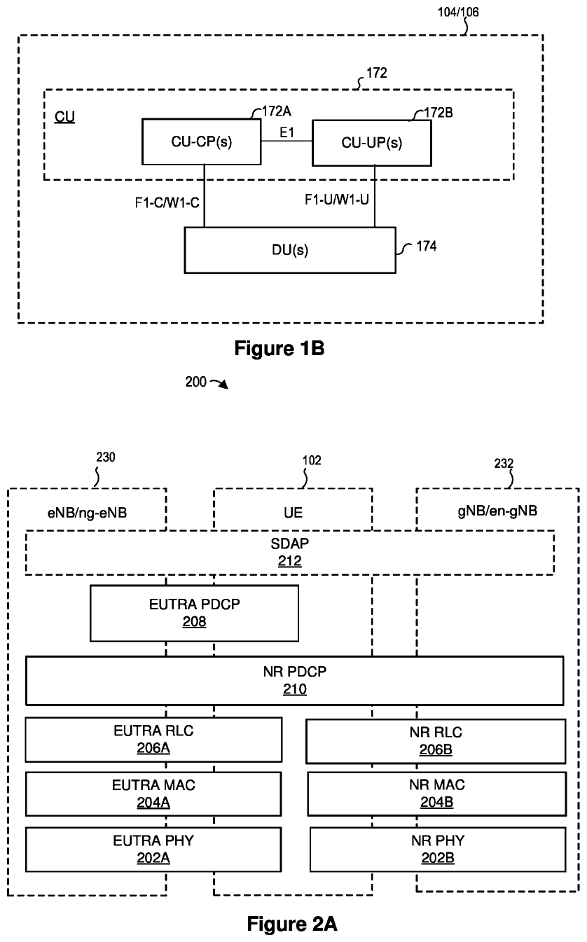

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core, in another example.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 160 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 implement the techniques of this disclosure to communicate data when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC), controlling mobility management (MM), controlling session management (SM), or refers to non-signaling, non-control-plane information at protocol layers above the layer of the protocol for controlling radio resources (e.g., RRC), above the layer of the protocol for controlling MM, above the layer of the protocol for controlling SM, or above the layer of the protocol for controlling quality of service (QOS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, then selects a cell of the base station 104, and exchanges data with the base station 104, either via the base station 106 or with the base station 104 directly, without transitioning to the RRC_CONNECTED state. In particular, the UE 102 and the base station 104 of the RAN 105 can communicate using early data transmission procedures, without the UE 102 transitioning to the RRC_CONNECTED state.

As a more specific example, the UE 102 in some cases transmits data in the uplink (UL) direction to the RAN 105 while the UE 102 operates in the RRC_INACTIVE or RRC_IDLE state.

After the UE 102 determines that data is available for uplink transmission while the UE 102 operates in the RRC_INACTIVE or RRC_IDLE state, the UE 102 can apply one or more security functions to the UL data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) of the UE 102 in the UL RRC message. The RAN 105 can identify the UE 102 based on the UE ID. In some implementations, the UE ID can be an inactive Radio Network Temporary Identifier (I-RNTI), resume identity, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function.

When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105, while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU, such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In such implementations, the UE 102 may omit a UE ID of the UE 102 from the UL MAC PDU. In yet other implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In other implementations, the UE can obtain the RRC MAC-I from the UL RRC message with an integrity key (e.g., K_{RRCint} key), an integrity protection algorithm, and other parameters COUNT (e.g., 32-bit, 64-bit or 128-bit value), BEARER (e.g., 5-bit value), and DIRECTION (e.g., 1-bit value).

In other implementations, the data is an uplink (UL) protocol data unit (SDU) of the NAS. The UE 102 applies the security function to the SDU and includes the secured SDU in a first UL PDU such as a NAS PDU, which can be associated with the NAS layer. For example, the NAS layer can be an MM sublayer or an SM sublayer of 5G, Evolved Packet System (EPS), or 6G. Then the UE 102 can include the UL NAS PDU in a second UL PDU, such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may omit an RRC MAC-I from the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an (d)encryption key). If the security-protected packet is an integrity-protected packet, the integrity protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. On the other hand, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an (d)encryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the data CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieve the data from the security-protected packet and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 that is currently operating in the RRC_INACTIVE or RRC_IDLE state, the base station 104 can apply at least one security function to the data to generate a security-protected packet, generate a first DL PDU including the security-protected packet, and include the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting integrity of the data and encrypt the data along with the MAC-I to generate an encrypted packet and an encrypted MAC-I. The base station 104 in some implementations generates a first DL PDU, such as a DL PDCP PDU including the security-protected packet, and then includes the first DL PDU in a second DL PDU associated with the MAC layer, for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, then includes the DL RLC PDU in the DL MAC PDU, and then transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU) including the DL RLC PDU and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI, or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In other implementations, the base station may assign the ID of the UE 102 to the UE 102 in an RRC message (e.g., an RRC release message or an RRC reconfiguration message) that the base station transmits to the UE 102 before transmitting the DCI and scrambled CRC, e.g., while the UE 102 was previously operating in the RRC_CONNECTED state, RRC_INACTIVE state, or RRC_IDLE state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 then can verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) from one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to transmit DL PDCP PDUs in accordance with which the base station 106 can transmit data in the downlink direction, in some scenarios, and receive UL PDCP PDUs in accordance with which the base station 106 can receive data in the uplink direction, in other scenarios. The processing hardware further can include an RRC controller 156 to implement procedures and messaging at the RRC sublayer of the protocol communication stack.

FIG. 1B depicts an example, distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

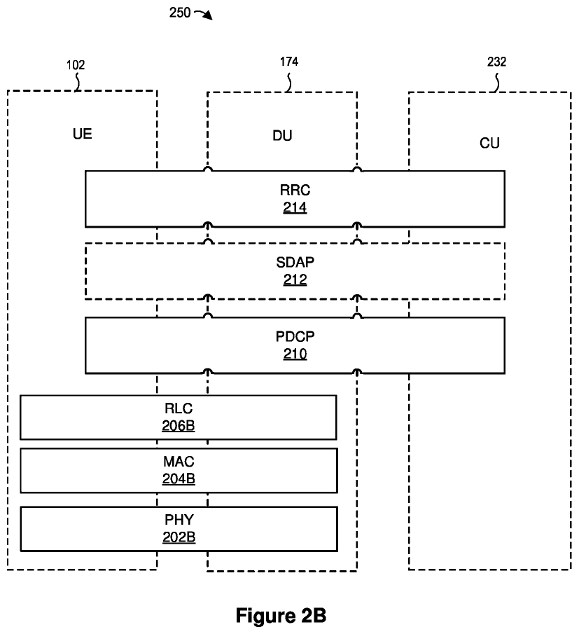

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

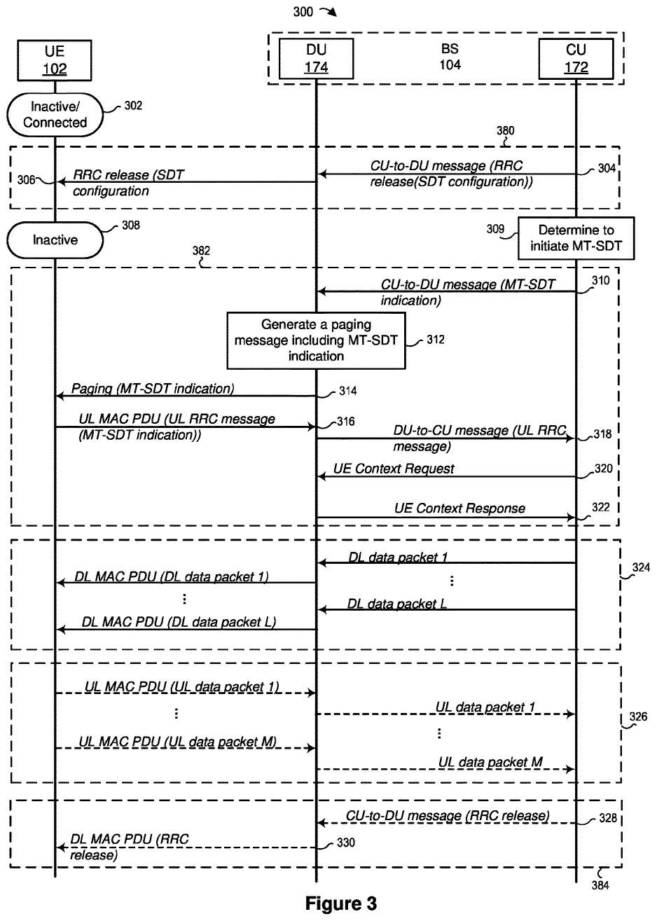

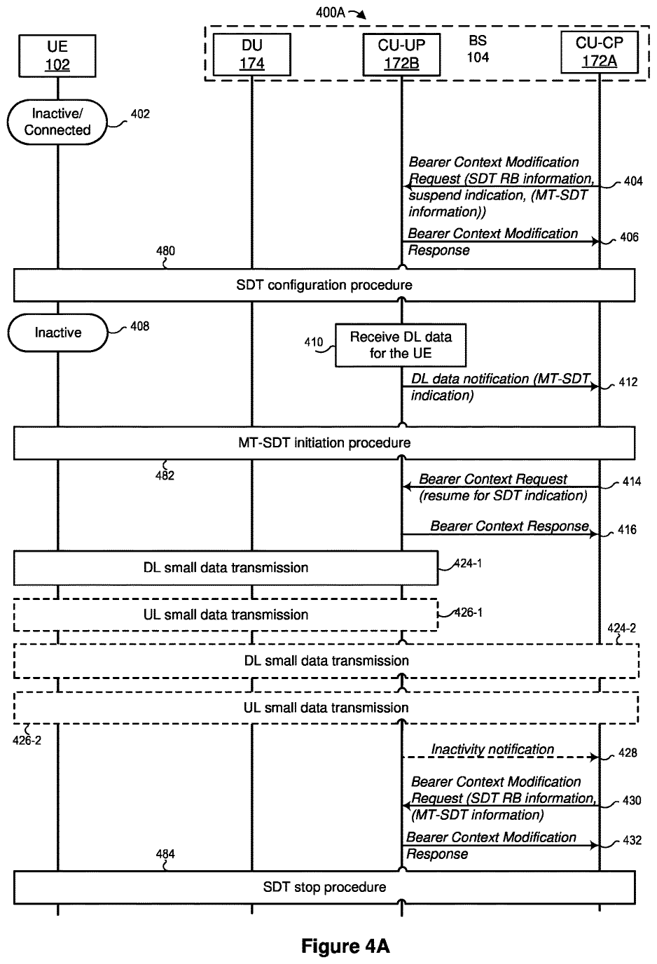

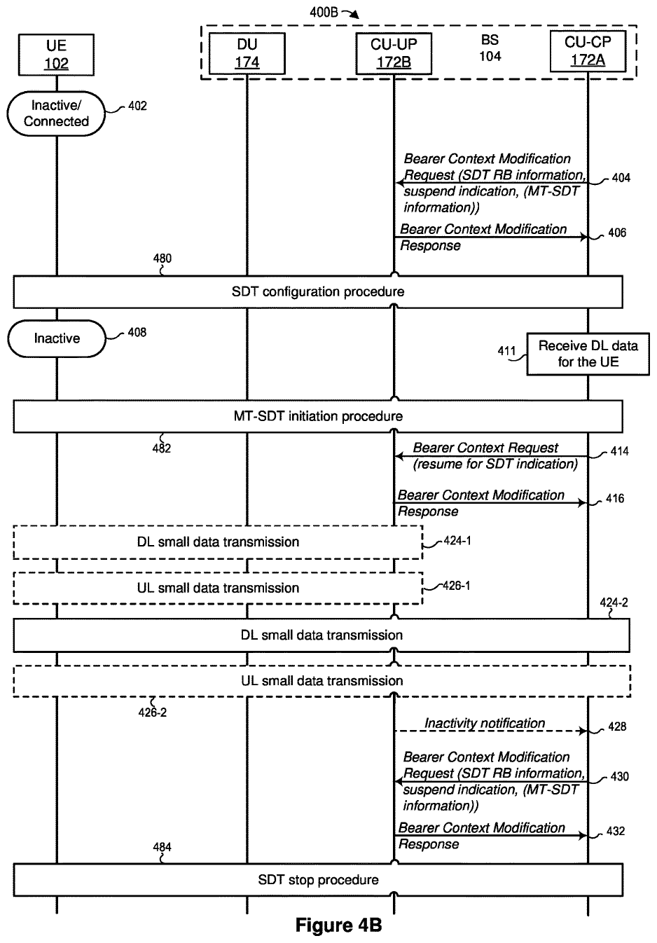

FIGS. 3 and 4A-4B are messaging diagrams of example scenarios in which a UE and nodes of a RAN implement the techniques of this disclosure for downlink early data transmission.

Referring first to FIG. 3, in a scenario 300, the base station 104 includes a CU 172 and a DU 174 and the UE 102 initially operates 302 in an inactive state (e.g., RRC_INACTIVE or RRC_IDLE) or a connected state (e.g., RRC_CONNECTED) with the base station 104 (e.g., the CU 172). In some implementations, after a (first) certain period of data inactivity for the UE 102, the CU 172 can determine that neither the base station 104 nor the UE 102 has transmitted any data in the downlink direction or the uplink direction, respectively, during the (first) certain period. In response to the determination, the CU 172 can generate a first RRC release message (e.g., RRCRelease message) to instruct the UE 102 to transition to the inactive state and transmit 304 a CU-to-DU message includes a first RRC release message to the DU 174. In turn, the DU 174 transmits 306 the first RRC release message to the UE 102. The UE 102 transitions 308 to the inactive state upon receiving the first RRC release message and operates 308 in the inactive state. In other implementations, the CU 172 transmits 304, 306 the first RRC release message to the UE 102 in response to receiving an RRC resume request message (e.g., RRCResumeRequest message or RRCResumeRequest1 message) from the UE 102 operating in the inactive state. The UE 102 remains 308 in the inactive state in response to receiving the first RRC release message. The CU 172 includes a SDT configuration in the first RRC release message to configure SDT for the UE 102. In some implementations, the CU-to-DU message is a UE Context Release Command message and the DU 174 transmits a UE Context Release Complete message to the CU, in response to the UE Context Release Command message. In other implementations, the CU-to-DU message is a DL RRC Message Transfer message.

In some implementations, the CU 172 can assign a UE identity/identifier (ID) (e.g., an I-RNTI or a resume ID) to the UE 102 and include the assigned value in the first RRC release message. In some implementations, the CU 172 can include a security parameter (e.g., Next Hop Chaining Count) in the first RRC release message.

In some implementations, the CU 172 includes a SDT DRB configuration (e.g., sdt-DRB-List field) configuring one or more DRBs for SDT in the SDT configuration. In some implementations, the CU 172 includes a SDT SRB configuration (e.g., sdt-SRB2-Indication field) configuring a SRB (e.g., SRB2) for SDT in the SDT configuration. In some implementations, the CU 172 includes an MT-SDT configuration in the SDT configuration or the first RRC release message to explicitly configure MT-SDT for the UE 102. In some implementations, the CU 172 receives UE capabilities (e.g., UE-NR-Capability IE) of the UE 102 from the UE 102, the CN 110 (e.g., the AMF 164) or the base station 106 before the event 304. The UE capabilities includes an MT-SDT capability indicating that the UE 102 supports MT-SDT because of the MT-SDT capability. Thus, the CU 172 determines to include or includes the MT-SDT configuration in the first RRC release message. If the UE capabilities of a UE does not include the MT-SDT capability, the CU 172 does not configure MT-SDT for the UE (e.g., if the UE capabilities of the UE 102 does not include the MT-SDT capability, the CU 172 does not include the MT-SDT configuration in the first RRC release message). In other implementations, the CU 172 does not include an MT-SDT configuration in the first RRC release message to configure MT-SDT for the UE 102 even though the UE 102 supports MT-SDT. In such cases, the UE 102 determines that the RAN 105 configures or initiates MT-SDT for the UE 102 when receiving, from the RAN 105, a paging message including the UE ID and an MT-SDT indication for the UE 102 as described for event 314. If a UE not supporting MT-SDT receives a paging message including a UE ID of the UE and an MT-SDT indication for the UE as described for event 314, the UE ignores or discards the MT-SDT indication and performs a (legacy) RRC connection resume procedure with the CU 172 via the DU 174 to transition to the connected state. In the (legacy) RRC connection resume procedure, the UE transmits an RRC resume request message (e.g., RRCResumeRequest message or RRCResumeRequest1 message) including a resume cause other than the MT-SDT cause to the CU 172 via the DU 174. Because the resume cause is set to a value other than the MT-SDT cause value or the RRC resume request message does not include an MT-SDT cause, the CU 172 transmits an RRC resume message (e.g., RRCResume message) to the UE 102 via the DU 174 to transition the UE 102 to the connected state. In response, the UE 102 transitions to the connected state and transmits an RRC resume complete message (e.g., RRCResumeComplete message) to the UE 102.

The events 304 and 306 are collectively referred to in FIG. 3 as a SDT configuration procedure 380. In some implementations, the UE 102 operates 302 in the inactive state or connected state with the CU 172 via another DU (i.e., a second DU) instead of the DU 174 (i.e., a first DU). In such cases, the CU 172 performs a SDT configuration procedure with the UE 102 via the second DU to configure SDT for the UE 102 and transition the UE 102 to the inactive state or keep the UE 102 in the inactive state, similar to the procedure 380. The UE 102 transitions 308 to the inactive state or remains 308 in the inactive state after (e.g., in response to) performing the SDT configuration procedure. In other implementations, the UE 102 operates 302 in the inactive state or connected state with the base station 106. In such cases, the base station 106 performs a SDT configuration procedure with the base station 106 to configure SDT for the UE 102 and transition the UE 102 to the inactive state or keep the UE 102 in the inactive state, similar to the SDT procedure 380. The UE 102 transitions 308 to the inactive state or remains 308 in the inactive state after (e.g., in response to) performing the SDT configuration procedure.

In some implementations, while the UE 102 operates 308 in the inactive state, the CU 172 receives DL data (e.g., DL data packet 1 in event 324) for the UE 102 from a core network node (e.g., the CN 110, AMF 164 or UPF 162). In the case that the UE 102 performs the SDT configuration procedure with the base station 106, while the UE 102 operates 308 in the inactive state, the CU 172 may receive a first BS-to-BS message (e.g., XnAP Paging message) including the UE ID of the UE 102 and an MT-SDT indication from the base station 106 to request paging the UE 102 for MT-SDT. The base station 106 transmits the first BS-to-BS message because the base station 106 receives DL data for the UE 102 from the core network node. The DL data in some example scenarios is an Internet Protocol (IP) packet, an Ethernet packet, or an application packet. In other scenarios, the DL data is a PDU (e.g., RRC PDU or PDCP PDU) that includes an RRC message, a NAS message, LTE positioning protocol (LPP) message, an IP packet, an Ethernet packet, or an application packet. Still further, the DL data in some scenarios can be an RRC PDU including a NAS PDU, such that the NAD PDU includes an IP packet, an Ethernet packet, or an application packet.

In response to receiving the DL data or the first BS-to-BS message, the CU 172 determines 309 to initiate MT-SDT. In response to the determination, the CU 172 transmits 310 a CU-to-DU message (e.g., F1 Application Protocol (F1AP) Paging message) to the DU 174 to cause the DU 174 to page the UE 102. The DU 174 generates 312 a paging message (e.g., RRC Paging message) to page the UE 102 in response to receiving the CU-to-DU message. In some implementations, the CU 172 includes a UE ID of the UE 102 in the CU-to-DU message. For example, the UE ID is the I-RNTI or resume ID. The DU 174 includes the UE ID in the paging message to address the UE 102. In some implementations, the DU 174 generates a paging record including the UE ID and includes the paging record in the paging message. The CU 172 includes a first MT-SDT indication in the CU-to-DU message to cause the DU 174 to include a second MT-SDT indication in the paging message. The first MT-SDT indication may be an information element (IE), field, or flag of the CU-to-DU message. The first MT-SDT indication notifies the DU 174 that the CU 172 has data available for the UE 102 that the UE 102 is to receive using SDT (i.e., without transitioning to the connected state). The DU 174 includes a second MT-SDT indication in the paging record or the paging message in response to the first MT-SDT indication. The DU 174 then transmits 314 the paging message to the UE 102. The second MT-SDT indication may be an IE, field, or flag generated by the DU and may be different than the first MT-SDT indication. The second MT-SDT indication instructs the UE 102 to initiate MT-SDT in order to receive DL data.

Upon receiving the paging message, the UE 102 generates a UL RRC message. The UE 102 includes a third MT-SDT indication in the UL RRC message in response to receiving the second MT-SDT indication in the paging message. The UE 102 then transmits 316 the UL RRC message to the DU 174, which in turn transmits 318 a DU-to-CU message including the UL RRC message to the CU 172. In some implementations, the UE 102 can include the UE ID in the UL RRC message that the UE 102 transmits 316. In some implementations, the UL RRC message can be an RRC resume request message (e.g., RRCResumeRequest message) and the third MT-SDT indication is a first resume cause (e.g., mt-SDT) indicating MT-SDT. The third MT-SDT indication indicates to the CU 172 that the UE 102 is initiating MT-SDT, instead of, for example, a legacy RRC connection resume procedure in which the UE 102 transitions to the connected state. Thus, the CU 172 refrains from transitioning the UE 102 to the connected state in response to receiving the third MT-SDT indication. In some implementations, the UE 102 generates a UL MAC PDU including the UL RRC message and transmits 316 the UL MAC PDU to the DU 174. The DU 172 retrieves the UL RRC message from the UL MAC PDU and includes the UL RRC message in the DU-to-CU message. In some implementations, if the UE 102 has UL data available for transmission, the UE 102 may include the UL data in the UL MAC PDU 316. In such cases, the UE 102 refrains from including an MT-SDT indication (e.g., the third MT-SDT indication) in the UL RRC message. For example, if the UL data includes UP data, the UE 102 may include a second resume cause set to mobile-originated data (mo-Data) instead of the including the first resume cause. For example, if the UL data includes CP data, the UE 102 may include a third resume cause set to mobile-originated signaling (mo-Signalling) instead of the including the first resume cause. Alternatively, in such cases, the UE 102 still includes the third MT-SDT indication in the UL RRC message. In other implementations, if the UE 102 has UL data available for transmission, the UE 102 may refrain including the UL data in the UL MAC PDU 316 and transmits the UL data in event 326. In some implementations, the DU-to-CU message is an Initial UL RRC Message Transfer message. In other implementations, the DU-to-CU message is a UL RRC Message Transfer message.

After receiving 318 the DU-to-CU message, the CU 172 may transmit 320 a UE Context Request message to the DU 174 to establish or modify a UE context for the UE 102 in the DU 174. In response, the DU 174 transmits 322 a UE Context Response message to the CU 172. In the UE Context Request message, the CU 172 can configure at least one UL tunnel for the DU 174 to transmit UL data packets (i.e., UP data packets) received from the UE 102 to the CU 172. In the UE Context Request message, the CU 172 includes a UL UP tunnel configuration (e.g., a UL UP Tunnel Information IE) to configure each of the at least one UL tunnel. In some implementations, each of the at least one UL UP tunnel configuration is associated with a DRB. In some implementations, each of the at least one UL UP tunnel configuration includes a Transport Layer Address and a Tunnel Endpoint Identifier (TEID). In some implementations, the Transport Layer Address is an IP address, and the TEID is a GPRS Tunneling Protocol (GTP) TEID.

In the UE Context Response message, the DU 174 can configure at least one DL tunnel for the CU 172 to transmit DL data packets (i.e., UP data packets) received from the CN 110 or edge server for the UE 102. In the UE Context Response message, the DU 174 includes a DL UP tunnel configuration (e.g., a DL UP Tunnel Information IE) to configure each of the at least one DL tunnel. In some implementations, each of the at least one DL UP tunnel configuration is associated with a DRB. In some implementations, each of the at least one DL UP tunnel configuration includes a Transport Layer Address and a TEID. In some implementations, the Transport Layer Address is an IP address, and the TEID is a GPRS Tunneling Protocol (GTP) TEID.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

The events 310, 312, 314, 316, 318, 320, and 322 are collectively referred to in FIG. 3 as an MT-SDT initiation procedure 382.

After receiving 304 the first RRC release message or 314 the paging message or initiating transmission of the UL RRC message 316, the UE 102 derives security keys (i.e., base key, integrity key(s) and/or encryption key(s)) using the security parameter. For example, the UE 102 derives a base key (e.g., K_{gNB}) using the security parameter and derives integrity key(s) (e.g., K_{RRCint} key and/or the K_{UPint} key) and encryption key(s) (e.g., K_{RRCenc} key and/or K_{UPenc} key) from the base key. The CU 172 derives security keys (i.e., same as the security keys derived by the UE 102) in a similar manner as the UE 102. The UE 102 and CU 172 use the integrity key (e.g., the K_{UPint} key) and/or encryption key (e.g., the K_{UPenc} key) in data communication in events 324 and 326. The UE 102 and CU 172 use the integrity key (e.g., the K_{RRCint} key) and/or encryption key (e.g., the K_{RRCenc} key) in communication of the second RRC release message in events 328 and 330.

Generally speaking, this disclosure refers to an “MT-SDT indication” as an indication that the UE 102 is to initiate, or is requesting to initiate, MT-SDT in order to receive DL data from the RAN 105 without transitioning to the connected state. An MT-SDT indication may be formatted in accordance with a suitable protocol, depending on the transmitter of the MT-SDT indication (e.g., a node of the RAN 105 or the UE 102) and the recipient or addressee of the MT-SDT indication. For example, in the scenario 300, the first MT-SDT indication that the CU 172 transmits 314 is included as an element of a CU-to-DU message addressed to the DU 174. The first MT-SDT indication may be formatted in accordance with a protocol having termination points at the CU 172 and the DU 174 (e.g., the F1AP). The second MT-SDT indication that the DU 174 transmits 314 is included as an element of a paging message or a paging record addressed to the UE 102. As discussed below with reference to event 316, the UE 102 may transmit third MT-SDT indication to the CU 172 via the DU 174 to indicate that the UE 102 is requesting to initiate MT-SDT, where the third MT-SDT indication may be formatted in accordance with a protocol having termination points at the UE 102 at the CU 172.

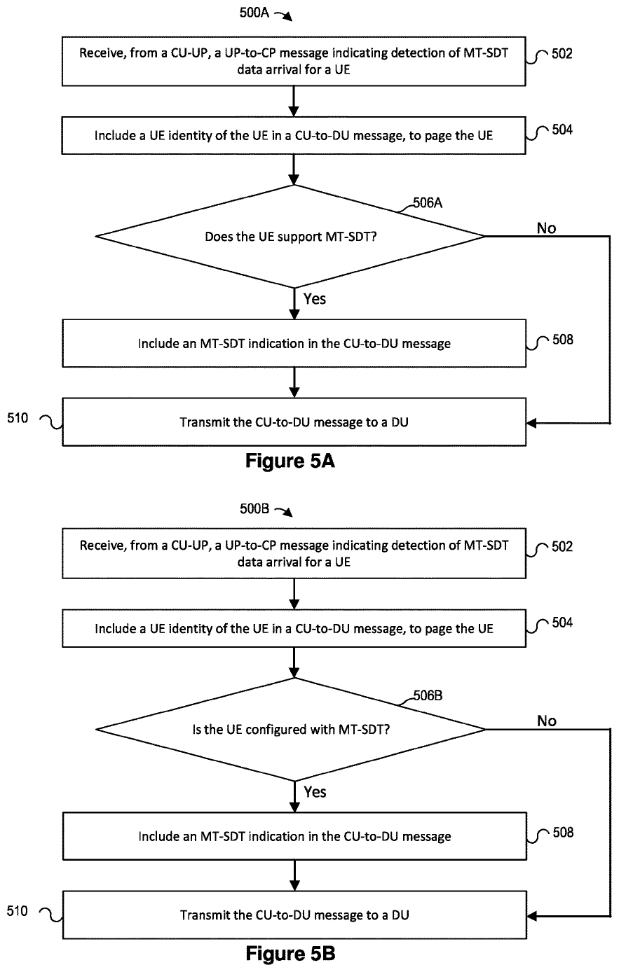

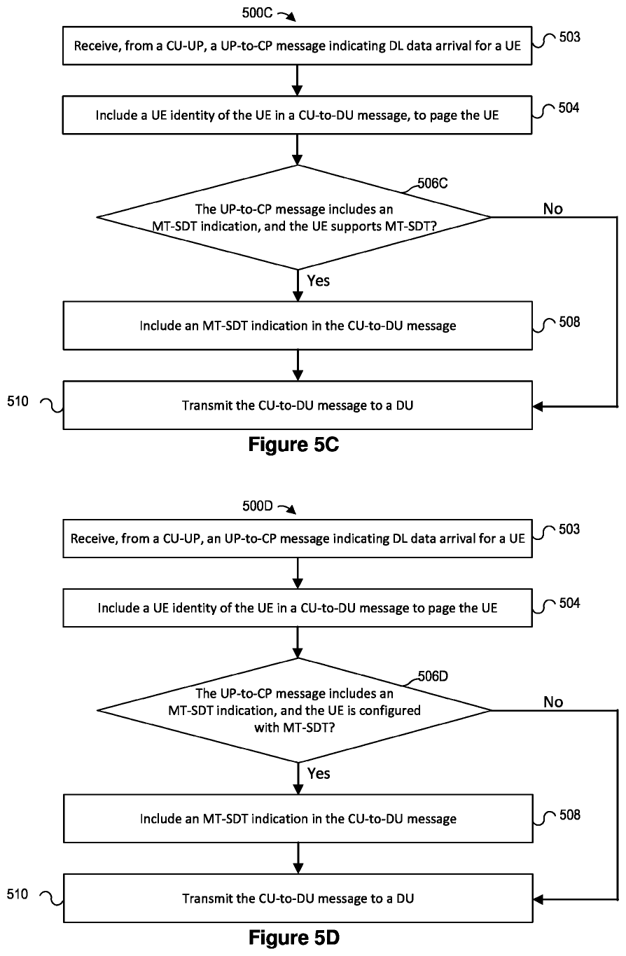

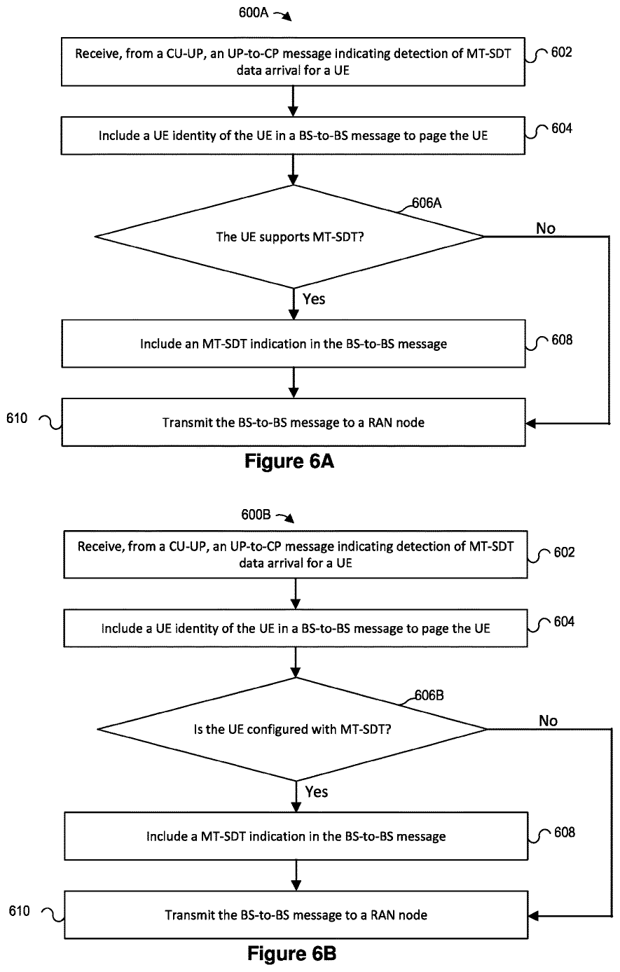

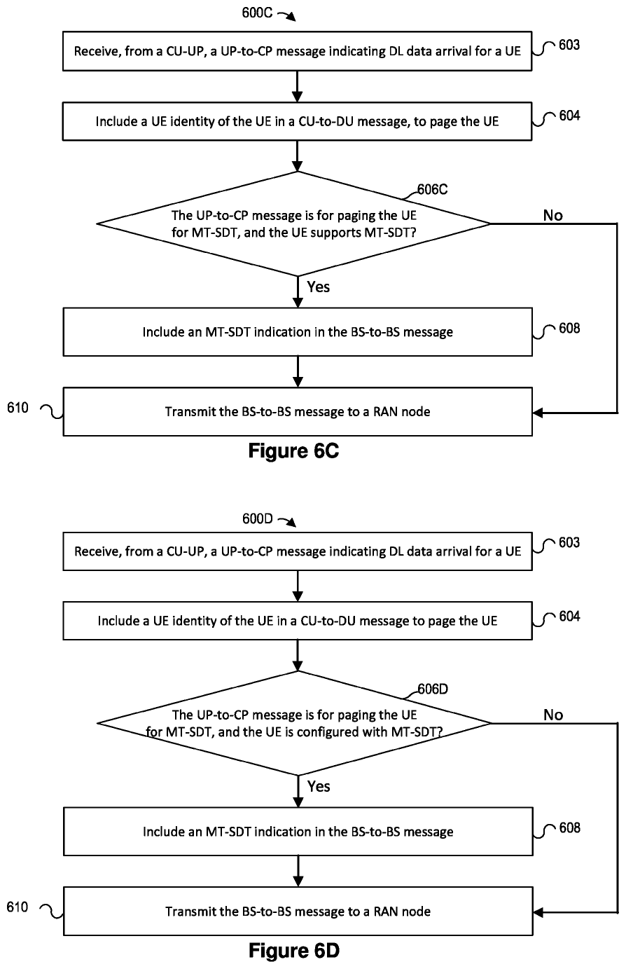

In some implementations, the CU 172 can determine whether the DL data qualifies for transmission in the inactive state in view of one or more of such factors as whether the DL data is associated with a radio bearer (e.g., DRB or SRB) configured for SDT and/or the UE 102 supports MT-SDT. Some of these factors will be further described in FIGS. 5A-6D. When the CU 172 determines that the DL data does not qualify for transmission in the inactive state, the CU 172 determines to initiate non-SDT to the UE 102 instead of the SDT. If the CU 172 determines to initiate non-SDT to the UE 102 instead of the SDT, the CU 172 can generate a second CU-to-DU message, include the UE ID in the second CU-to-DU message (e.g., F1AP Paging message) and exclude an SDT indication from the second CU-to-DU message. In response to the second CU-to-DU message excluding an SDT indication, the DU 174 can send a second paging message including the UE ID to the UE 102. In response to or after receiving the second paging message, the UE 102 can perform a (legacy) RRC connection resume procedure with the CU 172 via the DU 174 to transition to the connected state.

After receiving 322 the UE Context Setup Response message, the CU 172 can transmit 316 at least one downlink (DL) data packet for the UE 102 to the DU 174. The CU 172 can receive a DL data packet from the CN 110 or the edge server. In turn, the DU 174 can generate at least one DL MAC PDU including the at least one DL data packet and send 316 the at least one DL MAC PDU to the UE 102 operating in the inactive state. A DL MAC PDU in the at least one DL MAC PDU can include a particular DL data packet of the at least one DL data packet or include a segment of the particular DL data packet. In some implementations, the at least one DL data packet includes L DL data packets, where L is a positive integer, and may be less than a predetermined value. In some implementations, the CU 172 receives DL data packets 2, . . . , L during the procedure 382 or after transmitting the DL data packet 1. In some implementations, the DU 174 sends 324, to the UE 102, L DL MAC PDUs, where each includes a particular DL data packet of the at least one DL data packets. In other implementations, the DU 174 can send 324 to the UE 102 plural DL MAC PDUs each including a segment of a particular DL data packet. In yet other implementations, the DU 174 can send 324 to the UE 102 a DL MAC PDU including at least two DL data packets of the L data packets.

If the CU 172 receives DL data packet(s) of the DL data packets 1, . . . , L from a UP CN node (e.g., the UPF 162), the CU 172 transmits the DL data packet(s) to the DU 174 via the at least one DL tunnel. If the CU 172 receives DL data packet(s) of the DL data packets 1, . . . , L from a CP CN node (e.g., the AMF 164), the CU 172 transmits CU-to-DU message(s) (e.g., F1AP message(s) such as DL RRC Message Transfer message(s)) including the DL data packet(s) to the DU 174. In some implementations, each of the CU-to-DU message(s) includes a particular DL data packet of the DL data packet(s).

In some implementations, the UE 102 operating in the inactive state can send 326 at least one UL data packets to the CU 172 via the DU 174, after receiving some or all of the DL data packets 1, . . . , L. Specifically, the UE 102 generates at least one UL MAC PDU including the at least one UL data packet and send 326 the at least one UL MAC PDU to the DU 174. A UL MAC PDU in the at least one UL MAC PDU can include a particular UL data packet of the at least UL data packet or include a segment of the particular UL data packet. In some implementations, the at least one UL data packet includes M UL data packets, where M is an integer and greater than 0, and may be less than a predetermined value. In some implementations, the UE 102 sends 326 to the DU 174 M UL MAC PDUs, where each includes a particular UL data packet of the at least one UL data packets. In other implementations, the UE 102 can send to the DU 174 plural UL MAC PDUs each including a segment of a particular UL data packet. In yet other implementations, the UE 102 can send to the DU 174 a UL MAC PDU including at least two UL data packets of the M data packets.

After transmitting 324 the at least DL data packet and/or receiving 326 the at least one UL data packet, the CU 172 can determine to stop the SDT. In response to the determination, the CU 172 can transmit 328 a CU-to-DU message including a second RRC Release message to the DU 174, which in turn transmits 330 a DL MAC PDU including the second RRC release message to the UE 102. When the UE 102 receives 330 the second RRC release message, the UE 102 determines the SDT (session) ends and remains in the inactive state. In response to or after receiving the second RRC release message, the UE 102 stops attempting to receive a DL MAC PDU which includes a DL data packet and/or stops transmitting a UL MAC PDU which includes a UL data packet. In some implementations, the second RRC release includes a SDT configuration to configure SDT for the UE 102, similar to the SDT configuration in the first RRC release message. In other implementations, the second RRC release message does not include a SDT configuration to configure SDT for the UE 102. In such cases, the UE 102 continues using the SDT configuration received in the first RRC release message. In some implementations, the CU 172 can include a new UE ID (e.g., I-RNTI or resume identity) and/or a security parameter (e.g., Next Hop Chaining Count) in the second RRC release message. The UE 102 derives security keys (i.e., base key, integrity key(s) and/or encryption key(s)) using the security parameter. For example, the UE 102 derives a base key (e.g., K_{gNB}) using the security parameter and derives integrity key(s) (e.g., K_{RRCint} key and/or the K_{UPint} key) and encryption key(s) (e.g., K_{RRCenc} key and/or K_{UPenc} key) from the base key. The UE 102 uses the new UE ID, integrity key(s) and/or encryption key(s) in the next SDT (session) or a legacy RRC connection resume procedure with the RAN 105 to transition to the connected state. For example, the next SDT can be MT-SDT as described above. In another example, the next SDT can be mobile originated SDT (MO-SDT), i.e., the UE 102 initiates SDT with the RAN 105 without receiving a paging message. In this case, the MO-SDT can be a random access SDT (RA-SDT) or a configured grant SDT (CG-SDT).

Depending on the implementation, the CU 172 may or may not include a DL data packet in the CU-to-DU message that the CU 172 transmits 328. In one implementation, if the CU 172 does include a DL data packet in the CU-to-DU message, the DU 174 can include the DL data packet in the DL MAC PDU that the DU 174 transmits 330. In another implementation, the DU 174 can generate at least one additional DL MAC PDU (e.g., Y DL MAC PDUs, where Y is a positive integer) including (some or all of segments of) the DL data packet and transmits the at least one additional DL MAC PDU to the UE 102. In this implementation, the DU 174 may or may not include a segment of the DL data packet in the DL MAC PDU that the DU 174 transmits 330. The DU 174 transmits the at least one additional DL MAC PDU before the DU 174 transmits 322 the DL MAC PDU including the second RRC release message. In some implementations, the DU 174 may transmit 330 the DL MAC PDU after receiving hybrid automatic repeat request (HARQ) acknowledgement(s) for the additional DL MAC PDU.

In some implementations, the DU 174 transmits at least one DCI with a cyclic redundancy check (CRC) scrambled with at least one specific RNTI on PDCCH(s), to transmit 324 the DL MAC PDU(s) and/or 330 the DL MAC PDU, and/or to schedule the UE 102 to transmit 326 the UL MAC PDU(s). In response to or after receiving the second RRC release message, the UE 102 stops attempting to monitor or receive the at least one specific RNTI on PDCCH(s). The at least one specific RNTI can include a C-RNTI and/or a configured scheduling RNTI (CS-RNTI).

In some implementations, the CU-to-DU message the CU 172 transmits 328 can be a UE Context Release Command message. In response, the DU 174 can send to the CU 172 a UE Context Release Complete message. In other implementations, the CU-to-DU message the CU transmits 328 can be a DL RRC Message Transfer message or a UE Context Modification Request message. The DU 174 can send to the CU 172 a UE Context Modification Response message in response to the UE Context Modification Response message. In such cases, the CU 172 can send to the DU 174 another UE Context Release Command message for the UE 102 after sending 328 the CU-to-DU interface message to the DU 174. In response, the DU 174 can send to the CU 172 another UE Context Release Complete message. In yet other implementations, the CU-to-DU message that the CU 172 transmits 328 can be a new or existing F1AP message specified in 3GPP specification 38.473.

In some implementations, the UE 102 in the inactive state can perform a random access procedure with the DU 174 in response to receiving 314 the paging message or to transmit 316 the UL RRC message. For example, the random access procedure can be a four-step random access procedure or a two-step random access procedure. In the case of the four-step random access procedure, the UE 102 transmits a random access preamble to the base station 104 and in response, the base station 104 transmits to the UE 102 a random access response (RAR) including an uplink grant, and the UE 102 transmits 316 the UL MAC PDU in accordance with the uplink grant. The DU 174 receives 316 the UL MAC PDU in accordance with the uplink grant in the RAR. In the case of the two-step random access procedure, the UE 102 transmits 316 to the DU 174 a message A including a random access preamble and the UL MAC PDU in accordance with two-step random access configuration parameters. The UE 102 receives the two-step random access configuration parameters in system information broadcast by the DU 174 on cell 124 before transmitting 316 the UL MAC PDU. The DU 174 receives 316 the message A or the UL MAC PDU in accordance with the two-step random access configuration parameters. In other implementations, the UE 102 can transmit 316 the UL MAC PDU on radio resources configured in a CG configuration for SDT. The CU 172 can receive the CG configuration from the DU 174 and include the CG configuration in the first RRC release message or in the SDT configuration in the first RRC release message. Thus, the DU 174 receives 316 the UL MAC PDU on the radio resources in accordance with the CG configuration. In some implementations, the CU 172 can receive a CG configuration for the UE 102 from the DU 174 and includes the CG configuration in the second RRC release message or in the SDT configuration in the second RRC release message.

In the case that the CU 172 determines to initiate MT-SDT for the UE 102 in response to receiving the DL data for the UE 102, the CU 172 may transmit to the base station 106 a second BS-to-BS message (e.g., XnAP Paging message) including the UE ID of the UE 102 and an MT-SDT indication to request the base station(s) to page the UE 102 for MT-SDT. In response to receiving the second BS-to-BS message, a CU of the base station 106 transmits a CU-to-DU message including the UE ID and the first MT-SDT indication to a DU of the base station 106, similar to the event 310. The DU of the base station 106 generates a paging message including the UE ID and the second MT-SDT indication and transmits the paging message, similar to the events 312 and 314, respectively. If the UE 102 is in the coverage of the base station 106, the UE 102 transmits a UL RRC message to the DU in response to receiving the paging message, similar to the event 316 and the DU and CU performs actions similar to the events 318, 320, 322, 324, 326 and 384.

FIGS. 4A-4B illustrate scenarios that may be similar to the scenarios 300. However, FIGS. 4A-4B illustrate specific actions that may be performed by the control plane node (i.e., the CU-CP) and the user plane node (i.e., the CU-UP) of the CU. In particular, depending on the scenario, either the CU-CP or the CU-UP may determine to initiate SDT.

Turning first to FIG. 4A, in a scenario 400A, a base station 104 includes a DU 174, a CU-CP 172A, and a CU-UP 172B, where the CU-CP 172A and the CU-UP 172B are nodes of the CU 172. Events 402, 480, 408, 482, 424-1/424-2, 426-1/426-2, and 484 are similar to the events 302, 380, 308, 382, 324, 326, and 384, respectively. When the CU-CP 172A determines to configure SDT for the UE 102, the CU-CP 172 performs 480 the SDT configuration procedure with the DU 174 and UE 102, similar to the procedure 380.

In response to determining to configure SDT for the UE 102, the CU-CP 172A performs a Bearer Context Modification procedure by transmitting 404 a Bearer Context Modification Request message to the CU-UP 172B. In response, the CU-UP 172B transmits 406 a Bearer Context Modification Response message to the CU-CP 172A. In the Bearer Context Modification Request message, the CU-CP 172A includes SDT DRB information to configure one or more DRBs for SDT. In some implementations, the CU-CP 172A includes, in the Bearer Context Modification Request message, a suspend indication to indicate a bearer context of the UE 102 is suspended to the CU-UP 172B. The bearer context includes one or more bearers configured for the UE 102 for UP data communication. The bearer(s) includes at least one bearer configured for SDT (i.e., SDT bearer). In some implementations, the bearer(s) may include at least one bearer other than the SDT bearer (i.e., non-SDT bearer). The suspend indication indicates all of the bearer(s) is suspended. In some implementations, the CU-CP 172A includes, in the Bearer Context Modification Request message, MT-SDT information for the UE 102. Based on the MT-SDT information, the CU-UP 172B determines that that UE 102 is configured with MT-SDT. For example, the MT-SDT information indicates that MT-SDT is configured for the UE 102. In other alternative implementations, the CU-CP 172A does not include MT-SDT information in the Bearer Context Modification Request message. In such cases, the CU-UP 172B does not know whether the UE 102 is configured with MT-SDT. The CU-CP 172A can perform the Bearer Context Modification procedure (i.e., the events 404 and 406) with the CU-UP 172B before, during or after the SDT configuration procedure 480.

In some scenarios and implementations, the CU-CP 172A and CU-UP 172B communicate with the UE via another DU (i.e., a second DU) instead of the DU 174. In such cases, the CU-CP 172A performs a SDT configuration procedure with the UE via the second DU, similar to the procedures 380 and 480.

At a later time, while the UE 102 operates 408 in an inactive state, the CU-UP 172B receives 410 DL data (i.e., UP data) for the UE 102 from the CN 110 or an edge server. The DL data includes one or more DL data packets. In response to receiving the DL data, the CU-UP 172B initiates MT-SDT to transmit the DL data to the UE 102. In some implementations, the CU-UP 172B determines to initiate MT-SDT based on one or more factors. The factor(s) include a data volume threshold and/or an ID of a DRB, a PDU session or a QoS flow with which the DL data is associated. For example, the CU-UP 172B determines to initiate MT-SDT, because a size of the DL data is smaller than or equal to the data volume threshold and a particular ID of a DRB, a PDU session or a QoS flow with which the DL data is associated. In response to determining to initiate MT-SDT or initiating MT-SDT, the CU-UP 172B transmits 412 a DL data notification message including an MT-SDT indication to the CU-CP 172A. The DL data notification message indicates arrival of DL data for the UE 102, and the MT-SDT indication notifies the CU-CP 172A of the DL data (qualifying) for MT-SDT (i.e., without causing the UE 102 to transition to the connected state). After receiving 412 the DL data notification message, the CU-CP 172A performs an MT-SDT initiation procedure 482 with the DU 174 and the UE 102, similar to the procedure 382.

After (e.g., in response to) performing the MT-SDT initiation procedure 482 or receiving a message from the UE 102 or DU 174 in the MT-SDT initiation procedure 482, the CU-CP 172A performs a Bearer Context procedure with the CU-UP 172B. In the Bearer Context procedure, the CU-CP 172A transmits 414 a Bearer Context Request message to the CU-UP 172B to notify the CU-UP 172B that the UE 102 is connected to the CU-CP 172A or to request the CU-UP 172B to setup or modify a bearer context of the UE 102. The message can be a UL RRC message, a DU-to-CU message or a UE Context Response message, similar to the events 326, 318 and 320, respectively. In some implementations, the CU-CP 172A includes a resume for SDT indication in the Bearer Context Request message, and the resume for SDT indication indicates UP bearer(s) configured for SDT (i.e., SDT UP bearer(s)) for the UE 102 is resumed. Upon receiving the resume for SDT indication, the CU-UP 172B determines the SDT UP bearer(s) is resumed, and determines non-SDT UP bearer(s), if configured, is suspended.

The CU-UP 172B transmits 416 a Bearer Context Response message to the CU-CP 172A in response to the Bearer Context Request message. In some implementations, the Bearer Context Request message and the Bearer Context Response message are a Bearer Context Modification Request message and a Bearer Context Modification Response message, respectively. In other implementations, the Bearer Context Request message and the Bearer Context Response message are a Bearer Context Setup Request message and a Bearer Context Setup Response message, respectively.

After (e.g., in response to) receiving the Bearer Context Request message or transmitting the Bearer Context Response message, the CU-UP 172B then transmits 424-1 at least one DL data packet (i.e., UP data packet(s)) to the DU 174 via the DU 174 transmits 424-1, similar to the event 324. The CU-UP 172B receives the at least one DL data packet from a UP node (e.g., the UPF 162) in the CN 110. The at least one DL data packet includes the DL data packet(s) 410. During or after the DL small data transmission 424-1, if the UE 102 has at least UL UP data packet to transmit to the base station 104, the UE 102 can transmit 426-1 the at least one UL UP data packet to the CU-UP 172B via the DU 174, similar to event 326. The CU-UP 172B transmits the at least one UL UP data packet to the UP node. During or after the DL small data transmission 424-1, if the CU-CP 172A has at least DL CP data packet to transmit to UE 102, the UE 102 can transmit 424-2 the at least one DL CP data packet to the CU-CP 172A via the DU 174, similar to event 326. The CU-CP 172A may receive the at least DL CP data packet from a CP code (e.g., the AMF 164) in the CN 110. During or after the DL small data transmission 424-1, if the UE 102 has at least one UL CP data packet to transmit to the base station 104, the UE 102 can transmit 426-2 the at least one UL CP data packet to the CU-CP 172A via the DU 174, similar to event 326. The CU-CP 172A transmits the at least one UL CP data packet to the CP node.

If there is no additional DL data or UL data to communicate with the UE 102, the CU-UP 172B may transmit 428 an inactivity notification message (e.g., a Bearer Context Inactivity Notification message) to the CU-CP 172A to indicate (data) inactivity for the UE 102. In some implementations, after a certain period of data inactivity for the UE 102, the CU-UP 172B can determine that neither the base station 104 nor the UE 102 has transmitted any data in the downlink direction or the uplink direction, respectively, during the certain period. In response to the determination, the CU-UP 172B transmits 428 the inactivity notification message to the CU-CP 172A and the CU-CP 172A determines (data) inactivity for the UE 102 based on the inactivity notification message. In other implementations, the CU-UP 172B transmits a first data usage report message to the CU-CP 172A to report first data volume served by the CU-UP 172B for the UE 102. At a later time, the CU-UP 172B transmits a second data usage report message to the CU-CP 172A to report second data volume served by the CU-UP 172B for the UE 102. If the second data volume and the first data volume are the same, the CU-CP 172A determines (data) inactivity for the UE 102. When the CU-CP 172A determines that (data) inactivity for the UE 102, the CU-CP 172A initiates a Bearer Context Modification procedure with the CU-UP 172B by transmitting 430 a Bearer Context Modification Request message to the CU-UP 172B, similar to the event 404. In response, the CU-UP 172B transmits 432 a Bearer Context Modification Response message to the CU-CP 172A, similar to the event 406. When the CU-CP 172A determines that (data) inactivity for the UE 102, the CU-CP 172A performs 484 a SDT stop procedure with the UE 102 and DU 174, similar to the procedure 384. In some implementations, the CU-CP 172A performs the Bearer Context Modification procedure in parallel with the SDT stop procedure. In other implementations, the CU-CP 172A performs the Bearer Context Modification procedure before or after performing the SDT stop procedure.

Turning to FIG. 4B, a scenario 400B is generally similar to the scenario 400A, except that the CU-CP 172A receives 411 DL data for the UE 102 from the CP node (e.g., the AMF 164) in the CN 110 and determines to initiate MT-SDT for the UE 102 in response to receiving the DL data. In some implementations, the CU-CP 172A may determine whether the DL data qualifies for MT-SDT based on a size of the DL data. For example, if the size of the DL data is smaller or equal to a predetermined threshold, the CU-CP 172A determines to initiate MT-SDT for the UE 102. In response to initiating MT-SDT for the UE 102, the CU-CP 172A performs 482 the MT-SDT initiation procedure with the UE 102 and DU 174.

FIG. 5A is a flow diagram of an example method 500A for transmitting an interface message to a DU (e.g., the DU 174) to page a UE (e.g., the UE 102) for MT-SDT, which can be implemented by a CU-CP (e.g., the CU-CP 172A of the base station 104).

The method 500A begins at block 502, where the CU-CP receives, from a CU-UP, an UP-to-CP message indicating detection of MT-SDT data arrival for a UE (e.g., event 412). At block 504, the CU-CP includes a UE identity of the UE in a CU-to-DU message to page the UE (e.g., events 310, 382, 482). At block 506A, the CU-CP determines whether the UE supports MT-SDT. If the CU-CP determines that the UE supports MT-SDT at block 506A, the flow proceeds to blocks 508 and 510. At block 508, the CU-CP includes an MT-SDT indication in the CU-to-DU message (e.g., events 310, 382, 482). At block 510, the CU-CP transmits the CU-to-DU message to a DU (e.g., events 310, 382, 482). Otherwise, if the CU-CP determines that the UE does not support MT-SDT at block 506A, the flow skips block 508 and proceeds to block 510. In some implementations, the CU-CP refrains from including an MT-SDT indication in the CU-to-DU message to skip block 608.

In some implementations, the UP-to-CP message is an E1 application protocol (E1AP) message (e.g., DL Data Notification message). In some implementations, the CU-to-DU message is a F1 application protocol (F1AP) message (e.g., F1AP Paging message). In some implementations, the UE identity is an Inactive-Radio Network Temporary Identifier (I-RNTI) or a full Radio Network Temporary Identifier (full-RNTI).

FIG. 5B is a flow diagram of an example method 500B similar to the method 500A, except that the method 500B includes block 506B instead of block 506A. At block 506B, the CU-CP determines whether the UE is configured with MT-SDT. If the CU-CP determines that the UE is configured with MT-SDT at block 506B, the flow proceeds to blocks 508 and 510.

Otherwise, if the CU-CP determines that the UE is not configured with MT-SDT at block 506B, the flow skips block 508 and proceeds to block 510.

In some implementations, the CU-CP transmits, to the UE via the DU or another DU, an RRC release message configuring MT-SDT (e.g., events 328, 330, 384, 484). In such cases, the CU-CP may include an MT-SDT configuration (e.g., an MT-SDT indication) in the RRC release message to configure MT-SDT.

FIG. 5C is a flow diagram of an example method 500C similar to the method 500A, except that the method 500C includes blocks 503 and 506C instead of blocks 502 and 506A. At block 503, the CU-CP receives, from a CU-UP, an UP-to-CP message indicating detection of DL data arrival for a UE (e.g., event 412). At block 506C, the CU-CP determines whether the UP-to-CP message includes an MT-SDT indication and the UE supports MT-SDT. If the CU-CP determines that the UP-to-CP message includes a (first) MT-SDT indication and the UE supports MT-SDT at block 506C, the flow proceeds to blocks 508 and 510. At block 508, the CU-CP includes a second MT-SDT indication in the CU-to-DU message (e.g., events 310, 382, 482).

Otherwise, if the CU-CP determines that the UP-to-CP message does not include an MT-SDT indication or the UE does not support MT-SDT at block 506C, the flow skips block 508 and proceeds to block 510.

FIG. 5D is a flow diagram of an example method 500D similar to the method 500C, except that the method 500D includes block 506D instead of block 506C. At block 506D, the CU-CP determines whether the UP-to-CP message includes a (first) MT-SDT indication and the UE is configured with MT-SDT. If the CU-CP determines that the UP-to-CP message includes a (second) MT-SDT indication and the UE is configured with MT-SDT at block 506D, the flow proceeds to blocks 508 and 510. Otherwise, if the CU-CP determines that the UP-to-CP message does not include an MT-SDT indication or the UE is not configured with MT-SDT, the flow skips block 508 and proceeds to block 510.

FIG. 6A is a flow diagram of an example method 600A for transmitting an interface message to a base station (e.g., the base station 106 or the CU-CP 172A or CU 172 of the base station 106) to page a UE (e.g., the UE 102) for MT-SDT, which can be implemented by a CU-CP (e.g., the CU-CP 172A of the base station 104).

The method 600A begins at block 602, where the CU-CP receives, from a CU-UP, an UP-to-CP message indicating detection of MT-SDT data arrival for a UE (e.g., event 412). At block 604, the CU-CP includes a UE identity of the UE in a BS-to-BS message to page the UE. At block 606A, the CU-CP determines whether the UE supports MT-SDT. If the CU-CP determines that the UE supports MT-SDT at block 606A, the flow proceeds to blocks 608 and 610. At block 608, the CU-CP includes an MT-SDT indication in the BS-to-BS message. At block 610, the CU-CP transmits the BS-to-BS message to a RAN node (e.g., CU, CU-CP or base station). Otherwise, if the CU-CP determines that the UE does not support MT-SDT at block 606A, the flow skips block 608 and proceeds to block 610. In some implementations, the CU-CP refrains from including an MT-SDT indication in the BS-to-BS message to skip block 608.

In some implementations, the UP-to-CP message is an E1 application protocol (E1AP) message (e.g., DL Data Notification message). In some implementations, the BS-to-BS message is an Xn application protocol (XnAP) message (e.g., XnAP Paging message). In some implementations, the UE identity is an Inactive-Radio Network Temporary Identifier (I-RNTI) or a full Radio Network Temporary Identifier (full-RNTI).

FIG. 6B is a flow diagram of an example method 600B similar to the method 600A, except that the method 600B includes block 606B instead of block 606A. At block 606B, the CU-CP determines whether the UE is configured with MT-SDT. If the CU-CP determines that the UE is configured with MT-SDT at block 606B, the flow proceeds to blocks 608 and 610.

Otherwise, if the CU-CP determines that the UE is not configured with MT-SDT at block 606B, the flow skips block 608 and proceeds to block 610.

In some implementations, the CU-CP transmits, to the UE via the DU or another DU, an RRC release message configuring MT-SDT (e.g., events 328, 330, 384, 484). In such cases, the CU-CP may include an MT-SDT configuration (e.g., an MT-SDT indication) in the RRC release message to configure MT-SDT.

FIG. 6C is a flow diagram of an example method 600C similar to the method 600A, except that the method 600C includes blocks 603 and 606C instead of blocks 602 and 606A. At block 603, the CU-CP receives, from a CU-UP, an UP-to-CP message indicating detection of DL data arrival for a UE (e.g., event 412). At block 606C, the CU-CP determines whether the UP-to-CP message includes an MT-SDT indication and the UE supports MT-SDT. If the CU-CP determines that the UP-to-CP message includes an MT-SDT indication and the UE supports MT-SDT at block 606C, the flow proceeds to blocks 608 and 610. Otherwise, if the CU-CP determines that the UP-to-CP message does not include an MT-SDT indication or the UE does not support MT-SDT at block 606C, the flow skips block 608 and proceeds to block 610.

FIG. 6D is a flow diagram of an example method 600D similar to the method 600C, except that the method 600D includes block 606D instead of block 606C. At block 606D, the CU-CP determines whether the UP-to-CP message includes an MT-SDT indication and the UE is configured with MT-SDT. If the CU-CP determines that the UP-to-CP message includes an MT-SDT indication and the UE is configured with MT-SDT at block 606D, the flow proceeds to block 608. Otherwise, if the CU-CP determines that the UP-to-CP message does not include an MT-SDT indication or the UE is not configured with MT-SDT, the flow proceeds to block 610.

In some implementations, any of the methods 600A-600D can be combined with any of the methods 500A-500D.

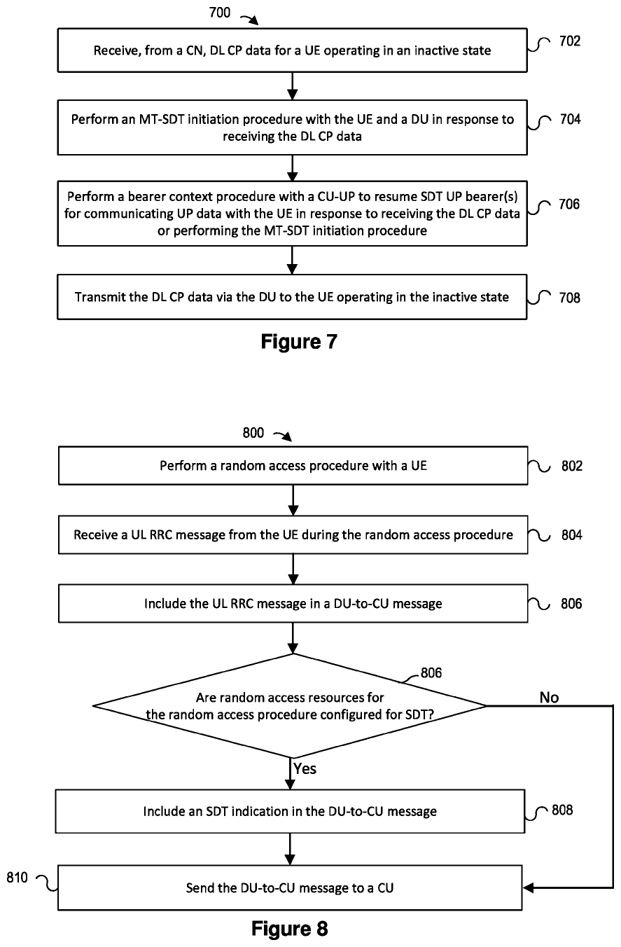

FIG. 7 is a flow diagram of an example method 700 for transmitting UP data and CP data to a UE (e.g., the UE 102) using MT-SDT, which can be implemented by a CU-CP (e.g., the CU-CP 172A of the base station 104).

The method 700 begins at block 702, where the CU-CP receives, from a CN, DL CP data for a UE operating in an inactive state (e.g., events 309, 411). At block 704, the CU-CP performs an MT-SDT initiation procedure with the UE and a DU in response to receiving the DL CP data (e.g., 382, 482). At block 706, the CU-CP performs a bearer context procedure with a CU-UP to resume SDT UP bearer(s) for communicating UP data with the UE in response to receiving the DL CP data or performing the MT-SDT initiation procedure (e.g., events 414, 416). At block 708, the CU-CP transmits the DL CP data via the DU to the UE operating in the inactive state (e.g., event 424-2).

In some implementation, the CU-CP receives UL CP data from the UE operating in the inactive state via the DU (e.g., event 426-2). In some implementations, after resuming the SDT UP bearer(s), the CU-UP may receive UL UP data transmitted by the UE operating in the inactive state (e.g., event 426-1). In other implementations, after resuming the SDT UP bearer(s), the CU-UP may receive DL UP data from the CN and transmits the DL UP data to the UE operating in the inactive state (e.g., event 424-1). If the CU-CP omits block 706, the CU-UP cannot communicate UL data and DL data for SDT with the UE.

In some implementations, the DL CP data includes one or more CP messages (e.g., RRC message(s), NAS message(s) or LPP message(s)). In some implementations, the UL CP data includes one or more CP messages (e.g., RRC message(s), NAS message(s) or LPP message(s)). In some implementations, the DL UP data includes one or more IP packets and/or one or more Ethernet packets. In some implementations, the UL UP data includes one or more IP packets and/or one or more Ethernet packets.

FIG. 8 is a flow diagram of an example method 800 for indicating a UE is initiating SDT to a CU (e.g., the CU 172 or CU-CP 172A of the base station 104), which can be implemented by a DU (e.g., the DU 174 of the base station 104).

The method 800 begins at block 802, where the DU performs a random access procedure with a UE. At block 804, the DU receives a UL RRC message from the UE during the random access procedure (e.g., events 316, 382, 482). At block 806, the DU includes the UL RRC message in a DU-to-CU message (e.g., events 318, 382, 482). At block 808, the DU determines whether the random access resources for the random access procedure are configured for SDT. If the DU determines that the random access resources for the random access procedure are configured for SDT at block 808, the flow proceeds to block 810. At block 810, the DU includes an SDT indication in the DU-to-CU message. Otherwise, if the DU determines that the random access resources for the random access procedure are not configured for SDT at block 808, the flow proceeds to block 812. At block 812, the DU sends the DU-to-CU message to a CU. That is, the DU refrains from including an SDT indication in the DU-to-CU message. The flow proceeds to block 810 from block 806 as well as from block 808.

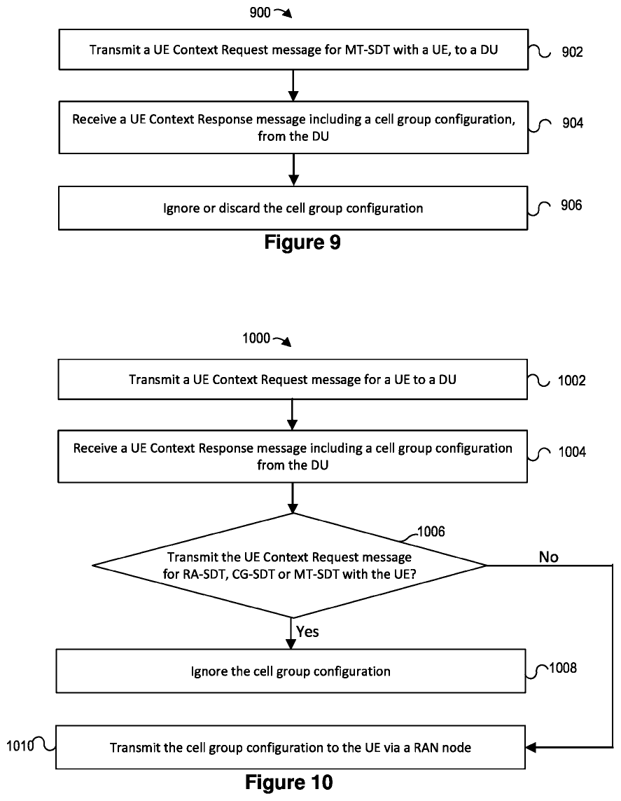

FIG. 9 is a flow diagram of an example method 900 for managing a cell group configuration received from a DU (e.g., the DU 174 of the base station 104), which can be implemented by a CU (e.g., the CU 172 or CU-CP 172A of the base station 104).

The method 900 begins at block 902, where the CU transmits a UE Context Request message for MT-SDT with a UE to a DU (e.g., events 320, 382, 482). At block 904, the CU receives a UE Context Response message including a cell group configuration from the DU (e.g., events 322, 382, 482). At block 906, the CU ignores or discards the cell group configuration. Because the CU ignores or discard the cell group configuration, the CU does not transmit an RRC message (e.g., RRCResume message) including the cell group configuration to the UE to transition the UE to a connected state (e.g., RRC_CONNECTED).

In some implementations, the cell group configuration is a CellGroupConfig IE as defined in 3GPP specification 38.331. In some implementations, the CU includes a SDT configuration in the UE Context Request message for MT-SDT with the UE. For example, the SDT configuration (e.g., SDT RLC Bearer Configuration) configures a RLC bearer for SDT.

The RLC bearer may be associated with a radio bearer (e.g., SRB or DRB). In another example, the SDT configuration (e.g., SDT Indicator Setup or SDT Indicator Modify) indicates a radio bearer (e.g., SRB or DRB) configured for SDT.

FIG. 10 is a flow diagram of an example method 1000 for managing a cell group configuration received from a DU (e.g., the DU 174 of the base station 104), which can be implemented by a CU (e.g., the CU 172 or CU-CP 172A of the base station 104).

The method 1000 begins at block 1002, where the CU transmits a UE Context Request message for a UE to a DU (e.g., events 320, 382, 482). At block 1004, the CU receives a UE Context Response message including a cell group configuration from the DU (e.g., events 322, 382, 482). At block 1006, the CU determines whether the UE transmitted the UE Context Request message for RA-SDT, CG-SDT or MT-SDT with the UE. If the CU determines that the CU transmitted the UE Context Request message for RA-SDT, CG-SDT or MT-SDT with the UE at block 1006, the flow proceeds to block 1008. At block 1008, the CU ignores or discards the cell group configuration. Otherwise, if the CU determines that the CU transmitted the UE Context Request message that is not related to RA-SDT, CG-SDT and/or MT-SDT with the UE at block 1006, the flow proceeds to block 1010. At block 1010, the CU transmits the cell group configuration to the UE via a RAN node. For example, the CU generates an RRC message including the cell group configuration and transmits the RRC message to the UE via the RAN node. In some implementations, the RAN node is the DU, another DU or a base station. In some implementations, the RRC message is an RRC resume message (e.g., RRCResume message) or an RRC reconfiguration message (e.g., RRCReconfiguration message).

In some implementations, the CU may include a SDT configuration in the UE Context Request message for RA-SDT, CG-SDT or MT-SDT with the UE. For example, the SDT configuration is a SDT RLC Bearer Configuration. In such cases, if the UE Context Request message includes the SDT configuration, the CU ignores or discards the cell group configuration. Otherwise, if the UE Context Request message does not include a SDT configuration, the CU transmits the cell group configuration to the UE via the RAN node.

In some implementations, the cell group configuration is a CellGroupConfig IE as defined in 3GPP specification 38.331. If the UE or the CU does not support CG-SDT, the “CG-SDT” described above can be omitted. If the UE or the CU does not support RA-SDT, the “RA-SDT” described above can be omitted.

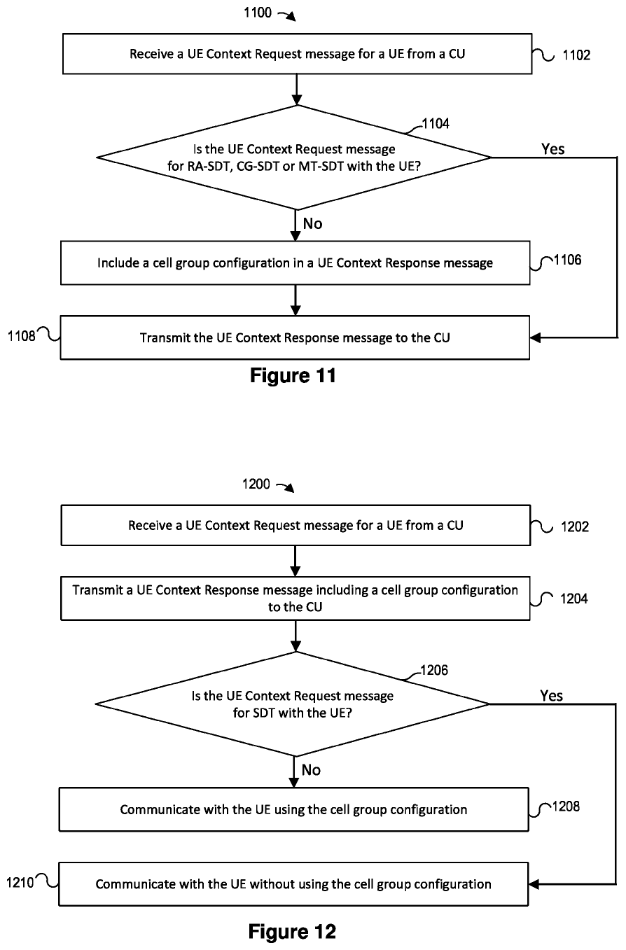

FIG. 11 is a flow diagram of an example method 1100 for transmitting a cell group configuration to a CU (e.g., the CU 172 or CU-CP 172A of the base station 104), which can be implemented by a DU (e.g., the DU 174 of the base station 104).

The method 1100 begins at block 1102, where the DU receives a UE Context Request message for a UE from a CU (e.g., events 320, 382, 482). At block 1104, the DU determines whether the UE Context Request message is for RA-SDT, CG-SDT or MT-SDT with the UE. If the DU determines that the UE Context Request message is not for RA-SDT, CG-SDT and/or MT-SDT with the UE at block 1104, the flow proceeds to blocks 1106 and 1108. At block 1106, the DU includes a cell group configuration in a UE Context Response message. In some implementations, the DU communicates with the UE using the cell group configuration after transmitting the cell group configuration to the CU. Otherwise, if the DU determines that the UE Context Request message is for RA-SDT, CG-SDT or MT-SDT with the UE at block 1104, the flow proceeds to block 1108. That is, the DU refrains from including a cell group configuration in the UE Context Response message. At block 1108, the DU transmits the UE Context Response message to the CU. In some implementations, the cell group configuration is a CellGroupConfig IE as defined in 3GPP specification 38.331.

In some implementations, the UE Context Request message may include a SDT configuration for RA-SDT, CG-SDT or MT-SDT with the UE. For example, the SDT configuration is a SDT RLC Bearer Configuration. In such cases, if the UE Context Request message includes the SDT configuration, the DU refrains from including a cell group configuration in the UE Context Response message. Otherwise, if the UE Context Request message does not include an SDT configuration, the DU includes a cell group configuration in the UE Context Response message. After receiving the cell group configuration, the CU transmits the cell group configuration to the UE via a RAN node (e.g., the DU, another DU or a base station).

In some implementations, the cell group configuration is a CellGroupConfig IE as defined in 3GPP specification 38.331. If the UE or the CU does not support CG-SDT, the “CG-SDT” described above can be omitted. If the UE or the CU does not support RA-SDT, the “RA-SDT” described above can be omitted.

FIG. 12 is a flow diagram of an example method 1200 for transmitting a cell group configuration to a CU (e.g., the CU 172 or CU-CP 172A of the base station 104), which can be implemented by a DU (e.g., the DU 174 of the base station 104).

The method 1200 begins at block 1202, where the DU receives a UE Context Request message for a UE from a CU (e.g., events 320, 382, 482). At block 1204, the DU transmits a UE Context Response message including a cell group configuration to the CU (e.g., events 322, 382, 482). At block 1206, the DU determines whether the UE Context Request message is for SDT with the UE. If the DU determines that the UE Context Request message is not for SDT with the UE at block 1206, the flow proceeds to block 1208. At block 1208, the DU communicates with the UE using the cell group configuration. Otherwise, if the DU determines that the UE Context Request message is for SDT with the UE at block 1206, the flow proceeds to block 1210. At block 1210, the DU communicates with the UE without using the cell group configuration. In some implementations, the DU ignores or discards the cell group configuration.

In some implementations, the UE Context Request message may include a SDT configuration for SDT with the UE. For example, the SDT configuration is a SDT RLC Bearer Configuration. In such cases, if the UE Context Request message includes the SDT configuration, the DU communicates with the UE without using the cell group configuration.

Otherwise, if the UE Context Request message does not include an SDT configuration, the DU communicates with the UE using the cell group configuration. In some implementations, the cell group configuration is a CellGroupConfig IE as defined in 3GPP specification 38.331. When the DU receives a UE Context Request message including a SDT configuration, the DU may not know the UE Context Request message is for RA-SDT or MT-SDT.

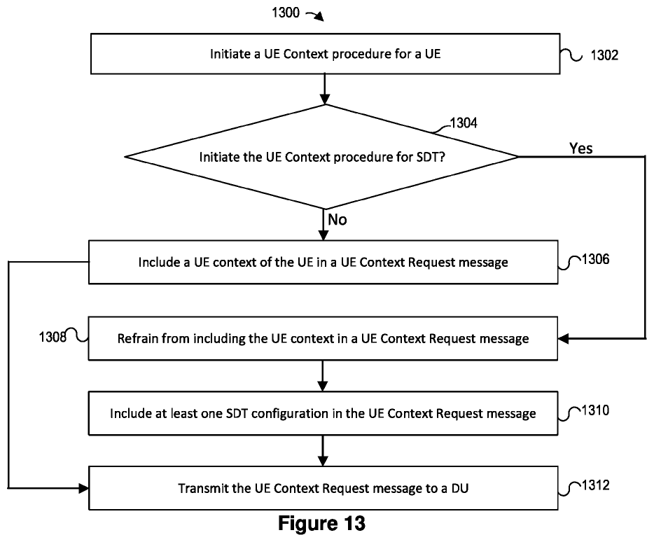

FIG. 13 is a flow diagram of an example method 1300 for transmitting a cell group configuration to a DU (e.g., the DU 174 of the base station 104), which can be implemented by a CU (e.g., the CU 172 or CU-CP 172A of the base station 104).

The method 1300 begins at block 1302, where the CU initiates a UE Context procedure for a UE. At block 1304, the CU determines whether the CU initiates the UE Context procedure for SDT (e.g., events 320, 382, 482). If the CU determines that the CU initiates the UE Context procedure for non-SDT at block 1304, the flow proceeds to block 1306. At block 1306, the CU includes a UE context of the UE in a UE Context Request message. For example, the UE context is or includes a cell group configuration (e.g., CellGroupConfig IE). The flow proceeds to block 1312 from block 1306. Otherwise, if the CU determines that the CU initiates the UE Context procedure for SDT at block 1304, the flow proceeds to block 1308. At block 1308, the CU refrains from including the UE context in a UE Context Request message. At block 1310, the CU includes at least one SDT configuration in the UE Context Request message. At block 1312, the CU transmits the UE Context Request message to a DU (e.g., events 320, 382, 482).

In some implementations, the at least one SDT configuration (e.g., SDT RLC Bearer Configuration(s)) configures RLC bearer(s) for SDT. For example, each of the at least one SDT configuration configures a particular RLC bearer. Each of the RLC bearer(s) may be associated with a radio bearer (e.g., SRB or DRB). In other implementations, the at least one SDT configuration (e.g., SDT Indicator Setup or SDT Indicator Modify) indicates radio bearer(s) (e.g., SRB and/or DRB(s)) configured for SDT. For example, each of the at least one SDT configuration indicates a particular radio bearer configured for SDT.

When the DU receives the UE Context Request message not including the UE context, the DU does not generate a cell group configuration for the UE or does not transmit a cell group configuration to the CU. Because the CU does not receive a cell group configuration for the UE, the CU remains the UE in the inactive state. Thus, the CU can communication with the UE using SDT (i.e., RA-SDT, CG-SDT or MT-SDT).

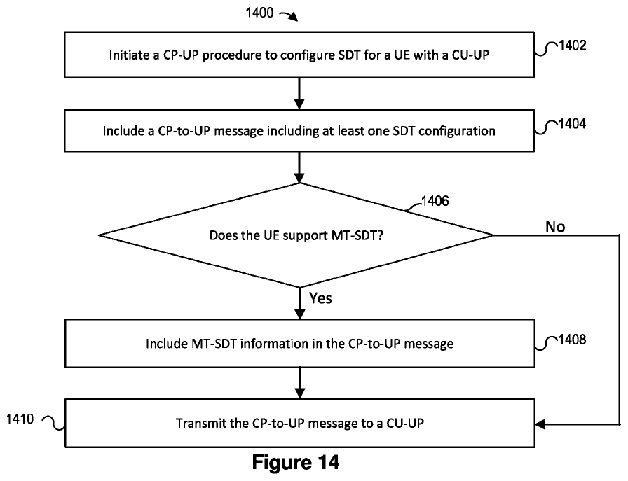

FIG. 14 is a flow diagram of an example method 1400 for transmitting an interface message to a CU-UP (e.g., the CU-UP 172B of the base station 104) to configure MT-SDT for a UE (e.g., the UE 102), which can be implemented by a CU-CP (e.g., the CU-CP 172A of the base station 104).

The method 1400 begins at block 1402, where the CU-CP initiates a CP-UP procedure to configure SDT for a UE with a CU-UP. In some implementations, the CP-UP procedure is a Bearer Context Modification procedure. At block 1404, the CU-CP includes a CP-to-UP message including at least one SDT configuration (e.g., event 404). At block 1406, the CU-CP determines whether the UE supports MT-SDT. If the CU-CP determines that the UE supports MT-SDT at block 1406, the flow proceeds to blocks 1408 and 1410. At block 1408, the CU-CP includes MT-SDT information in the CP-to-UP message (e.g., event 404). At block 1410, the CU-CP transmits the CP-to-UP message to a CU-UP (e.g., events 404). Otherwise, if the CU-CP determines that the UE does not support MT-SDT at block 1406, the flow skips block 1408 and proceeds to block 1410. In some implementations, the CU-CP refrains from including an MT-SDT information in the CP-to-UP message to skip block 1408.

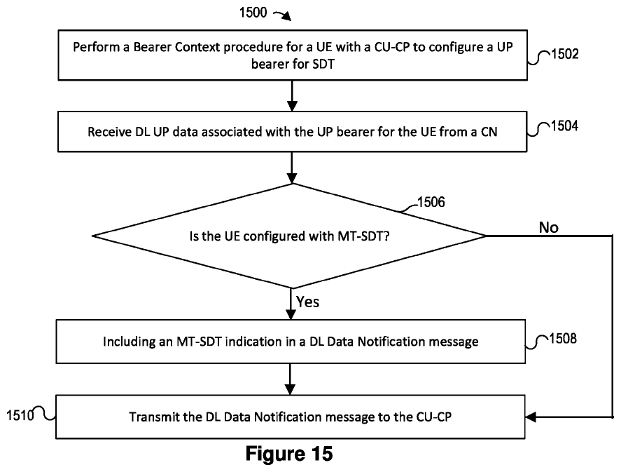

FIG. 15 is a flow diagram of an example method 1500 for transmitting an interface message to a CU-CP (e.g., the CU-CP 172A of the base station 104) to indicate arrival of DL data for a UE (e.g., the UE 102), which can be implemented by a CU-UP (e.g., the CU-UP 172B of the base station 104).

The method 1500 begins at block 1502, where the CU-UP Perform a Bearer Context procedure for a UE with a CU-CP to configure a UP bearer for SDT. In some implementations, the Bearer Context procedure is a Bearer Context Modification procedure. In other implementations, the Bearer Context procedure is a Bearer Context Setup procedure. In some implementations, the UP bearer is a DRB. At block 1504, the CU-UP receives DL UP data associated with the UP bearer for the UE from a CN (e.g., event 410). At block 1506, the CU-UP determines whether the UE is configured with MT-SDT. If the CU-UP determines that the UE is configured with MT-SDT at block 1506, the flow proceeds to blocks 1508 and 1510. At block 1508, the CU-UP includes an MT-SDT indication in the DL Data Notification message (e.g., event 412). At block 1510, the CU-UP transmits the DL Data Notification message to a DU (e.g., event 412). Otherwise, if the CU-UP determines that the UE is not configured with MT-SDT at block 1506, the flow skips block 1508 and proceeds to block 1510. In some implementations, the CU-UP refrains from including an MT-SDT indication in the DL Data Notification message to skip block 1508.

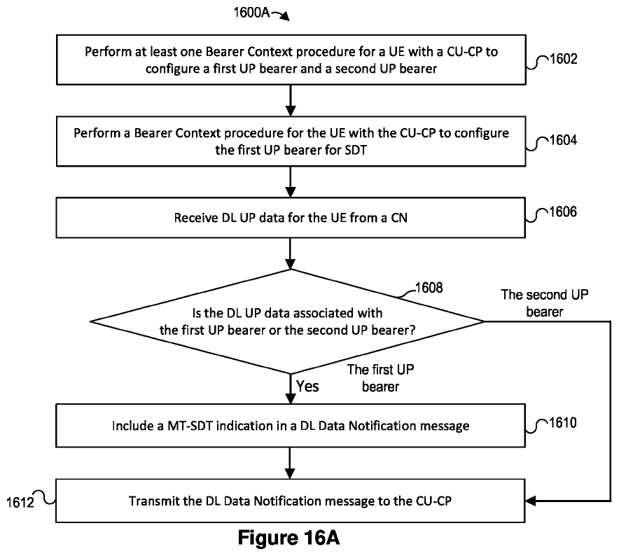

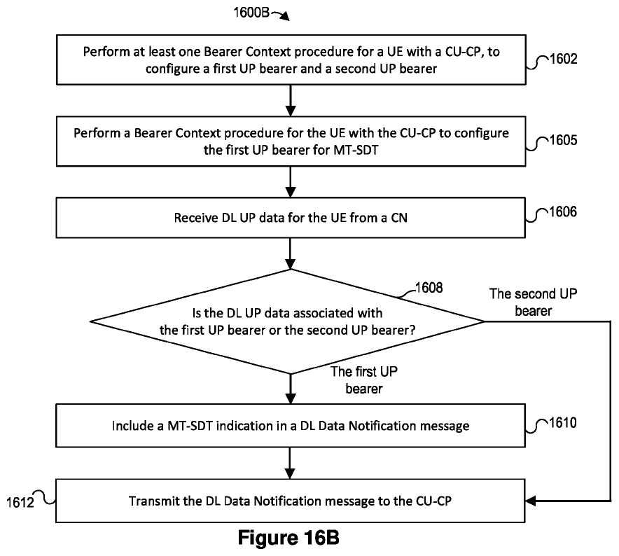

FIG. 16A is a flow diagram of an example method 1600A for transmitting an interface message to a CU-CP (e.g., the CU-CP 172A of the base station 104) to indicate arrival of DL data for a UE (e.g., the UE 102), which can be implemented by a CU-UP (e.g., the CU-UP 172B of the base station 104).

The method 1600 begins at block 1602, where the CU-UP Perform at least one Bearer Context procedure for a UE with a CU-CP to configure a first UP bearer and a second UP bearer. In some implementations, the at least one Bearer Context procedure includes Bearer Context Modification procedure(s) and/or Bearer Context Setup procedure(s). In some implementations, the first UP bearer and second UP bearer are DRBs. At block 1604, the CU-UP performs a Bearer Context procedure for the UE with the CU-CP to configure the first UP bearer for SDT (e.g., events 404, 406). In some implementations, the “SDT” generally refers to MT-SDT and MO-SDT. The MO-SDT can include RA-SDT and/or CG-SDT. In such cases, the CU-UP does not perform a Bearer Context procedure for the UE with the CU-CP to configure the second UP bearer for SDT. In other words, the second UP bearer is not configured for SDT.

At block 1606, the CU-UP receives DL UP data for the UE from a CN (e.g., event 410). At block 1608, the CU-UP determines whether the DL UP data is associated with the first UP bearer or the second UP bearer. If the CU-UP determines that the DL UP data is associated with the first UP bearer at block 1608, the flow proceeds to blocks 1610. At block 1610, the CU-UP includes an MT-SDT indication in the DL Data Notification message (e.g., event 412). At block 1612, the CU-UP transmits the DL Data Notification message to a DU (e.g., event 412). Otherwise, if the CU-UP determines that the DL UP data is not associated with the first UP bearer at block 1608 (i.e., the DL UP data is associated with the second UP bearer), the flow skips block 1610 and proceeds to block 1612. The CU-UP skips block 1610 because the CU-UP identifies that the second UP bearer is configured for SDT. In some implementations, the CU-UP refrains from including an MT-SDT indication in the DL Data Notification message to skip block 1610.

FIG. 16B is a flow diagram of an example method 1600B similar to the method 1600A, except that the method 1600B includes block 1605 instead of block 1604. At block 1605, the CU-UP performs a Bearer Context procedure for the UE with the CU-CP to configure the first UP bearer for MT-SDT (e.g., events 404, 406). In some implementations, the CU-UP does not perform a Bearer Context procedure for the UE with the CU-CP to configure the second UP bearer for MT-SDT. In other words, the second UP bearer is not configured for MT-SDT. In such cases, the Bearer Context procedure at block 1605 may configure the second bearer for MO-SDT. Alternatively, the CU-UP does not perform a Bearer Context procedure for the UE with the CU-CP to configure the second UP bearer for MO-SDT. The CU-UP skips block 1610 because the CU-UP identifies that the second UP bearer is configured for MT-SDT.

The following list of examples reflects a variety of the embodiments explicitly contemplated by the present disclosure.

Example 1. A method for managing transmission from a radio access network (RAN) to a user equipment (UE) operating without an active radio connection with the RAN, the method implemented in a central unit (CU) of a distributed base station including the CU and a distributed unit (DU), the method comprising: transmitting, from a control plane (CP) entity of the CU to a user plane (UP) entity of the CU, information related to a capability of the UE to receive data when the UE operates without an active radio connection with the RAN; in response to determining that data is available for transmission to the UE operating without an active radio connection with the RAN, and accordance with the capability of the UE, initiating transmission of the data to the UE at the CP entity of the CU.

Example 2. The method of example 1, wherein the data is associated with mobile-terminated small data transmission (MT-SDT).

Example 3. The method of example 1 or 2, wherein the determining that the data is available for transmission includes: receiving, at the UP entity of the CU, downlink (DL) data for the UE; and transmitting, from the UP entity of the CU to the CP entity of the CU, an indication of DL data.

Example 4. The method of example 3, wherein the data includes an Internet Protocol (IP) packet.

Example 5. The method of example 3, wherein the data includes an Ethernet packet.

Example 6. The method of example 3, wherein the data includes an application packet.

Example 7. The method of example 1 or 2, wherein the determining that the data is available for transmission includes receiving, at the CP entity of the CU, DL data for the UE.

Example 8. The method of example 7, wherein the data includes a non-access stratum (NAS) message.

Example 9. The method of example 7, wherein the data includes an LTE positioning protocol (LPP) message.

Example 10. The method of any of the preceding examples, wherein the transmitting of the information related to the capability of the UE includes transmitting the information in a request to modify a bearer context for the UE.

Example 11. The method of example 10, further comprising including, in the request, radio bearer information for small data transmission.

Example 12. The method of example 10, further comprising providing, to the UE via the DU, configuration for MT-SDT.

Example 13. A method for managing transmission from a RAN to a UE operating without an active radio connection with the RAN, the method implemented a CU of a distributed base station including the CU and a DU, the method comprising: detecting, at the CU, that data is available for transmission to the UE currently operating without an active radio connection with the RAN; in response to determining that the UE is capable of receiving the data, transmitting, from the CU to another RAN node, an indication that the RAN is to transmit the data to the UE while the UE continues to operate without an active radio connection with the RAN.

Example 14. The method of example 13, wherein the indication that the RAN is to transmit the data includes an MT-SDT indication.

Example 15. The method of example 13 or 14, wherein the other RAN node is the DU of the distributed base station.

Example 16. The method of example 13 or 14, wherein the other RAN node is a peer base station operating in the RAN.

Example 17. The method of any of examples 13-16, wherein the indication that the RAN is to transmit the data includes an MT-SDT indication.

Example 18. The method of any of examples 13-17, wherein the detecting includes: receiving the data at a CP entity of the CU.

Example 19. The method of any of examples 13-17, wherein the detecting includes receiving, at the CP entity from a UP entity of the CU, an indication that the UP entity received the data.

Example 20. The method of any of examples 13-16, wherein the transmitting of the indication includes initiating paging of the UE.

Example 22. A method for managing communication between a RAN and a UE operating without an active radio connection with the RAN, the method implemented a DU of a distributed base station including a CU and the DU, the method comprising: receiving, from the UE during a random access procedure associated with a set of resources, an uplink message for the CU; when the set of resources is configured for communicating data with a UE that does not have an active radio connection with the RAN, including, in a DU-to-CU message, an indication of data communication when the UE that does not have an active radio connection with the RAN; and transmitting the DU-to-CU message to the CU.

Example 23. The method of example 22, wherein the indication includes an SDT indication.

Example 24. The method of example 23, wherein the SDT indication is an MO-SDT indication.

Example 25. The method of example 23, wherein the SDT indication is an MT-SDT indication.

Example 26. The method of any of examples 22-25, wherein the UE operating without an active radio connection with the RAN operates in an RRC_INACTIVE state.

Example 27. The method of any of examples 22-25, wherein the UE operating without an active radio connection with the RAN operates in an RRC_IDLE state.

Example 28. A base station comprising: a transceiver; and processing hardware configured to implement a method according to any of the preceding examples.

The following additional considerations apply to the foregoing discussion.

In some implementations, the paging message can be replaced by a paging record. In other implementations, the paging message can include one or more paging records, where each paging record pages a particular UE. For example, the paging message can include a paging record for the UE 102.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method implemented in a central unit (CU) of a distributed base station including the CU and a distributed unit (DU), the method comprising:
receiving, at a user plane (UP) entity of the CU (CU-UP) from a control plane (CP) entity of the CU (CU-CP), a request to modify a bearer context for a user equipment (UE), the request including information related to mobile-terminated small data transmission (MT-SDT);
receiving, at the CU-UP and in an inactive state of a radio connection between the UE and a radio access network (RAN), downlink (DL) data for the UE; and
transmitting, from the CU-UP to the CU-CP, an indication of the DL data, the indication including an MT-SDT indication, based on the information related to the MT-SDT received from the CU-CP.

2. The method of claim 1, wherein:
the request to modify the bearer context for the UE includes SDT data radio bearer (DRB) information to configure a DRB for the MT-SDT.

3. The method of claim 2, wherein:
the bearer context includes the DRB for the MT-SDT and at least one non-SDT bearer.

4. The method of claim 2 or 3, further comprising:
determining to initiate the MT-SDT to transmit the DL data when a size of the DL data is smaller than or equal to a data volume threshold of the DRB.

5. The method of any of claims 2-4, further comprising:
determining to initiate the MT-SDT to transmit the DL data based on an identity of the DRB.

6. The method of any of the preceding claims, wherein:
the request to modify the bearer context for the UE includes a suspend indication to indicate the bearer context of the UE is suspended.

7. The method of any of the preceding claims, wherein:
the request to modify the bearer context for the UE includes a Bearer Context Modification Request message.

8. The method of any of the preceding claims, further comprising:
determining, at the CU-UP, that that UE is configured for the MT-SDT.

9. The method of claim 8, wherein:
the determining that that UE is configured for the MT-SDT is based on the information related to the MT-SDT received from the CU-CP.

10. The method of any of the preceding claims, further comprising:
determining to initiate the MT-SDT to transmit the DL data based on a packet data unit (PDU) session with which the DL data is associated.

11. The method of any of the preceding claims, further comprising:
determining to initiate the MT-SDT to transmit the DL data based on a quality-of-service (QoS) flow with which the DL data is associated.

12. The method of any of the preceding claims, wherein:
the MT-SDT indication is a first MT-SDT indication;
the method further comprising:
transmitting, to the DU, a message including a second MT-SDT indication.

13. The method of claim 12, wherein the message including the second MT-SDT indication is a request to page the UE.

14. The method of claim 12 or 13, wherein:
the transmitting of the message including the second MT-SDT indication is in response to determining that the UE supports the MT-SDT.

15. A base station comprising processing hardware and configured to implement a method of any of the preceding claims.
